(19) United States
(12) Patent Application Publication
(10) Pub. No.: US 2025/0030023 A1
(43) Pub. Date: Jan. 23, 2025

(54) FUEL CELL SYSTEM AND METHOD FOR OPERATING A FUEL CELL SYSTEM

(71) Applicant: Robert Bosch GmbH, Stuttgart (DE)

(72) Inventor: Gregory Rewers, Schwieberdingen (DE)

(21) Appl. No.: 18/709,211

(22) PCT Filed: Nov. 21, 2022
(86) PCT No.: PCT/EP2022/082608

§ 371 Date: May 10, 2024

(30) Foreign Application Priority Data
Nov. 26, 2021 (DE) 10 2021 213 328.2

(51) Int. Cl. H01M 8/04828; H01M 8/04119; H01M 8/0432; H01M 8/0438; H01M 8/04492; H01M 8/04701; H01M 8/04746

(52) U.S. Cl. CPC H01M 8/04835; H01M 8/04141; H01M 8/04335; H01M 8/0435; H01M 8/04395; H01M 8/0441; H01M 8/04432; H01M 8/04522; H01M 8/04708; H01M 8/04753; H01M 8/04149

(57) ABSTRACT

A method for operating a fuel cell system comprises: feeding an oxidation gas stream to a cathode inlet of a cathode of a fuel cell of the fuel cell system; feeding a cathode exhaust gas stream from a cathode outlet of the cathode to an exhaust gas inlet of the humidifier; discharging the cathode exhaust gas stream from the humidifier via an exhaust gas outlet of the humidifier; humidifying the oxidation gas stream in the humidifier by means of the water extracted from the cathode exhaust gas stream; determining at least one of the following indicators for the moisture content of the cathode exhaust gas: a pressure drop between the cathode inlet and the cathode outlet, a pressure drop between the exhaust gas inlet and the exhaust gas outlet of the humidifier, a first temperature difference of the cathode exhaust gas stream between the exhaust gas inlet and the exhaust gas outlet of the humidifier, a second temperature difference of the oxidation gas stream between the oxidation gas inlet and the oxidation gas outlet of the humidifier, and varying a moisture feed to the cathode inlet and/or moisture removal from the cathode by adjusting at least one operating parameter of the fuel cell system on the basis of the at least one determined indicator.

### BACKGROUND

The present invention relates to a fuel cell system and a method for operating a fuel cell system.

Fuel cells are being increasingly used as energy converters, among other things in vehicles, in order to directly convert the chemical energy contained in a fuel, e.g., hydrogen together with oxygen, into electrical energy. Fuel cells typically comprises an anode, a cathode and an electrolytic membrane arranged between the anode and cathode. Oxidation of the fuel occurs at the anode, and a reduction of oxygen occurs at the cathode.

The cathode side is fed with an oxygen-containing oxidation gas stream, typically ambient air, at an oxidation gas inlet. The oxidation gas is generally compressed and humidified to a predetermined moisture content by means of a humidifier. The reduction of oxygen on the cathode side produces water that is at least partially discharged at an oxidation gas outlet with the constituents of the oxidation gas stream that do not react at the cathode. The cathode exhaust gas stream is fed to the humidifier, where the water/water vapor contained in the cathode exhaust gas is partially fed to the oxidation gas flowing to the cathode for humidification.

If the electrolytic membrane of the fuel cells dries out too much, the performance of the fuel cell decreases as the transport of protons through the membranes becomes more difficult. Further, drying out the membrane can also damage it. Conversely, if too much water is conveyed into the fuel cell, there is a risk of flooding, which makes it more difficult to feed the oxygen atoms to the reaction site and also reduces the performance of the fuel cell. Depending on the operating state of the fuel cell, it is therefore desirable to adjust an optimal water mass flow in the oxidation gas inlet or an optimal moisture content of the oxidation gas flow.

U.S. Pat. No. 8,993,186 B2 discloses a method for countering drying out of a fuel cell system, whereby a first temperature difference is detected between the oxidation gas flowing into a cathode inlet and the cathode exhaust gas flowing out of a cathode outlet of the fuel cell and compared with a first temperature limit value. If the temperature difference exceeds the first temperature limit value, a drying-out state of the fuel cell system is detected and corresponding countermeasures are initiated, such as limiting an electrical current generated by the fuel cell. Further, a second temperature difference of a coolant that cools the fuel cell is determined between a coolant inlet and a coolant outlet, and the presence of a fuel cell drying-out state is detected if the determined second temperature difference exceeds a second temperature limit value.

### SUMMARY

Provided according to the invention is a method for operating a fuel cell system and a fuel cell system.

According to a first aspect of the invention, a method for operating a fuel cell system comprises: feeding an oxidation gas stream to a cathode inlet of a cathode of a fuel cell of the fuel cell system; feeding a cathode exhaust gas stream from a cathode outlet of the cathode to an exhaust gas inlet of the humidifier; discharging the cathode exhaust gas stream from the humidifier via an exhaust gas outlet of the humidifier; humidifying the oxidation gas stream in the humidifier by means of the water extracted from the cathode exhaust gas stream; determining at least one of the following indicators for the moisture content of the cathode exhaust gas: a pressure drop between the cathode inlet and the cathode outlet, a pressure drop between the exhaust gas inlet and the exhaust gas outlet of the humidifier, a first temperature difference of the cathode exhaust gas stream between the exhaust gas inlet and the exhaust gas outlet of the humidifier, a second temperature difference of the oxidation gas stream between the oxidation gas inlet and the oxidation gas outlet of the humidifier. The method further comprises a moisture feed to the cathode inlet and/or moisture removal from the cathode by adjusting at least one operating parameter of the fuel cell system on the basis of the at least one determined indicator.

According to a second aspect of the invention, a fuel cell system, which can be provided for use in a vehicle, for example, comprises at least one fuel cell, at least one fuel cell having an anode, a cathode, an electrolytic membrane arranged between the anode and the cathode, an anode inlet for feeding fuel to the anode, an anode outlet for discharging exhaust gas from the anode, a cathode inlet for feeding oxidation gas to the cathode, and a cathode outlet for discharging cathode exhaust gas from the cathode, a humidifier having an oxidation gas inlet, an oxidation gas outlet connected to the cathode inlet, an exhaust gas inlet connected to the cathode inlet and an exhaust gas outlet, whereby the humidifier is configured to extract water and water vapor from cathode exhaust gas coming from the cathode outlet and to humidify oxidation gas flowing from the oxidation gas inlet to the oxidation gas outlet with the extracted water, a sensor system configured to detect a pressure between the oxidation gas outlet and the cathode inlet and a pressure between the cathode outlet and the exhaust gas inlet and/or a pressure between the cathode outlet and the exhaust gas inlet and downstream of the exhaust gas outlet and/or a temperature between the exhaust downstream of the exhaust gas outlet, and/or a temperature between the cathode outlet and the exhaust gas inlet and downstream of the exhaust gas outlet and/or a temperature between the cathode inlet and the oxidation gas outlet of the humidifier and upstream of the oxidation gas inlet of the humidifier, and a control device, which is connected to the sensor system in a signal-conducting manner and is configured to output control signals for changing at least one operating parameter of the fuel cell system to cause the fuel cell system to perform a method according to the first aspect of the invention.

One idea underlying the invention is, on the basis of a pressure drop occurring at the cathode of a gas flowing from the cathode inlet to the cathode outlet and/or on the basis of a pressure drop occurring in the cathode exhaust gas stream when flowing through a humidifier, and/or on the basis of a temperature change in the cathode exhaust gas stream occurring when flowing through the humidifier, and/or on the basis of a temperature change in the oxidation gas occurring when flowing through the humidifier, to draw a conclusion about the moisture conditions at the cathode, e.g. whether a water mass flow fed to the cathode via the oxidation gas is outside of a predetermined range. The pressure drops and/or temperature difference determined are indicators of the moisture content in the cathode exhaust gas stream. Given that moisture input to the cathode, which occurs in addition to the product water produced at the cathode, takes place substantially exclusively via the oxidation gas, the moisture content of the cathode exhaust gas can be used to draw conclusions about the moisture content of the oxidation gas. Generally, the pressure drop across the cathode or from the exhaust gas inlet to the exhaust gas outlet of the humidifier increases with increasing moisture content in the gas, as the mass flow increases with increasing moisture content for a given mass flow of dry gas. In the humidifier, water is withdrawn from the cathode exhaust gas between the exhaust gas inlet and the exhaust gas outlet, e.g., at a membrane, and fed to the oxidation gas stream, e.g., via diffusion of water through the membrane. This leads to cooling of the cathode exhaust gas stream. It has been found that the resulting temperature difference increases with increasing moisture content in the cathode exhaust gas stream. In order to maintain an actual value of the respective pressure drop and/or the temperature difference within a predetermined target range, the water mass flow fed to the cathode via the oxidation gas and/or the water mass flow discharged from the cathode, e.g. via the cathode exhaust gas or via other means, is varied according to the invention based on the determined indicators by changing at least one operating parameter of the fuel cell system.

One advantage of the invention is that the moisture is not detected directly, e.g. via a humidity sensor, but indirectly via a pressure and/or temperature measurement. This enables faster adjustment of the operating parameters. A further advantage is that a relatively precise control of the moisture content on the cathode is facilitated.

According to some embodiments, it can be provided that determining the pressure drop between the cathode inlet and the cathode outlet comprises detecting a pressure between the humidifier and the cathode inlet, detecting a pressure between the cathode outlet and the exhaust gas inlet of the humidifier and a calculating a pressure difference between the detected pressures, or detecting a pressure difference between the cathode inlet and the cathode outlet. Accordingly, both a differential pressure sensor can be used to directly measure the pressure drop as the pressure difference between the cathode inlet and the cathode outlet, or the pressures can be measured using different pressure sensors and the difference between the pressures representing the pressure drop are subsequently measured, e.g., by means of the control device.

According to some embodiments, it can be provided that determining the pressure drop between the exhaust gas inlet and the exhaust gas outlet of the humidifier comprises detecting a pressure between the cathode outlet and the exhaust gas inlet of the humidifier, detecting a pressure downstream of the exhaust gas outlet of the humidifier and calculating a pressure difference between the detected pressures, or detecting a pressure difference between the exhaust gas inlet and the exhaust gas outlet of the humidifier. Accordingly, both a differential pressure sensor can be used to directly measure the pressure drop as the pressure difference between the exhaust gas outlet and the exhaust gas inlet, or the pressures can be measured using different pressure sensors and the difference between the pressures representing the pressure drop are subsequently measured, e.g., by means of the control device.

According to some embodiments, it can be provided that determining the first temperature difference of the cathode exhaust gas stream between the exhaust gas inlet and the exhaust gas outlet of the humidifier comprises detecting a temperature between the cathode outlet and the exhaust gas inlet of the humidifier, detecting a temperature downstream of the exhaust gas outlet of the humidifier and calculating the difference between the detected temperatures. The temperatures can each be detected by means of a temperature sensor and the difference calculated by means of the control device. An advantage of measuring the temperatures is that it can be measured precisely and quickly with very cost-efficient sensors, which makes it easy to control the moisture input in such a way that the measured actual temperature difference is kept within a predetermined temperature target range.

According to some embodiments, it can be provided that determining the second temperature difference of the oxidation gas stream between the oxidation gas inlet and the oxidation gas outlet of the humidifier comprises detecting a temperature between the oxidation gas outlet of the humidifier and the cathode inlet, detecting a temperature upstream of the oxidation gas inlet of the humidifier, and calculating the difference between the detected temperatures.

According to some embodiments, it can be provided that the at least one operating parameter of the fuel cell system is varied such that the determined first and/or second temperature difference is maintained in a range between 5° C. and 15° C., in particular between 8° C. and 12° C.

According to some embodiments, it can be provided that varying a moisture feed to the cathode inlet comprises feeding the oxidation gas stream to the cathode inlet at least partially via a first bypass line bypassing the humidifier. In this case, the oxidation gas stream is thus guided at least partially past the humidifier and is thus not additionally humidified. Thus, a relatively dry oxidation gas stream is fed to the cathode, which can receive and remove additional water at the cathode. The proportion of the oxidation gas stream directed through the bypass line and the proportion of the oxidation gas stream directed through the humidifier in the total oxidation gas stream thus represents an operating parameter of the fuel cell system, that when changed advantageously provides a highly effective variation of the moisture feed to the cathode inlet.

The optional first bypass line connects a point of a flow path of the oxidation gas stream upstream of the oxidation gas inlet of the humidifier to a point of the flow path between the oxidation gas outlet of the humidifier and the cathode inlet while bypassing the humidifier.

According to some embodiments, it can be provided that, for at least partially feeding the oxidation gas stream to the cathode inlet via the first bypass line, an opening degree of a first bypass valve is adjusted on the basis of the at least one determined indicator. The optional first bypass valve arranged in the first bypass line can, e.g., be connected to the control device and be actuated by the control device. In other words, an opening degree of the bypass valve defined by a flow cross-section can therefore be set by an actuation or control signal output from the control device between, e.g., a closed state in which the flow cross-section is completely blocked and an open state in which the flow cross-section is fully open. Optionally, the flow cross-section can be continuously varied or in discrete stages between the closed and open state. The control device outputs the control signal based on the determined indicator for the moisture content in the cathode exhaust gas stream. For example, it can be provided that the opening degree or the flow cross-section of the bypass valve is increased when the respective determined pressure difference and/or the temperature difference increases in order to direct a greater proportion of the oxidation gas stream past the humidifier in each case so that the moisture input into the cathode is reduced, as described hereinabove.

According to some embodiments, it can be provided that varying a moisture feed to the cathode inlet comprises discharging the cathode exhaust gas stream from the cathode outlet at least partially via a second bypass line bypassing the humidifier. Accordingly, the cathode exhaust gas stream is guided at least partially past the humidifier so that the water in the cathode exhaust gas stream is not available for humidification of the oxidation gas. As a result, the moisture input into the oxidation gas in the humidifier is reduced, effectively reducing the moisture feed to the cathode inlet. The proportion of the cathode gas stream directed through the second bypass line and the proportion of the cathode exhaust gas stream directed through the humidifier in the total cathode exhaust gas stream thus represents an operating parameter of the fuel cell system, that when changed advantageously provides a highly effective variation of the moisture feed to the cathode inlet.

The optional second bypass line connects a point of a flow path of the cathode exhaust gas stream located between the exhaust gas outlet of the humidifier and the cathode outlet to a point of the flow path of the cathode exhaust gas stream located downstream of the exhaust gas outlet of the humidifier while bypassing the humidifier.

According to some embodiments, it can be provided that for at least partially discharging the cathode exhaust gas stream from the cathode outlet via the second bypass line, an opening degree of a second bypass valve is adjusted on the basis of at least one determined indicator. For example, the optional second bypass valve arranged in the second bypass line can be connected to the control device and can be actuated by the control device. In other words, an opening degree of the bypass valve defined by a flow cross-section can thus be adjusted by an actuation or control signal output from the control device, e.g., between a closed state in which the flow cross-section is completely blocked and an open state in which the flow cross-section is fully open. Optionally, the flow cross-section can be continuously varied or in discrete stages between the closed and open state. The control device outputs the control signal based on the determined indicator for the moisture content in the cathode exhaust gas stream. For example, it can be provided that the opening degree or the flow cross-section of the bypass valve is increased when the respective determined pressure difference and/or the temperature difference increases in order to direct a greater proportion of the cathode exhaust gas stream past the humidifier in each case so that the moisture input into the cathode is reduced, as described hereinabove.

According to some embodiments, it can be provided that varying the moisture feed to the cathode inlet and/or the moisture removal from the cathode comprises adjusting a variation of the oxidation gas mass flow, in particular by changing a rotational speed of a compressor conveying the oxidation gas, or by changing an opening position of a pressure control valve connected to the cathode outlet, as a change of the operating parameter. In this way, the mass gas flow at the cathode is decreased or increased to change the moisture content.

According to some embodiments, it can be provided that varying the moisture feed to the cathode inlet and/or the moisture removal from the cathode comprises varying a temperature of the cathode as a change in the operating parameter in order to vary an evaporation power at the cathode, in particular by changing a coolant mass flow cooling the fuel cell. By changing the temperature, the evaporation power can be effectively changed and thus more or less gaseous water can be carried away via the cathode exhaust gas stream.

According to some embodiments, it can be provided that varying moisture removal from the cathode comprises discharging liquid water from the cathode via a drain valve. Here, based on the at least one determined indicator, a drain valve, which is fluidically connected to a flow path between the cathode inlet and the cathode outlet, is opened in order to discharge liquid water from the cathode when the respective detected pressure or temperature difference is outside the respective target range.

### BRIEF DESCRIPTION OF THE DRAWINGS

The invention is explained below with reference to the figures of the drawings. The drawings show:

FIG. 1 a schematic view of a hydraulic circuit diagram of a fuel cell system according to an exemplary embodiment of the invention; and

FIG. 2 a flowchart of a method for operating a fuel cell system according to an exemplary embodiment of present invention.

### DETAILED DESCRIPTION

In the drawings, identical reference signs denote identical or functionally identical components, unless stated otherwise.

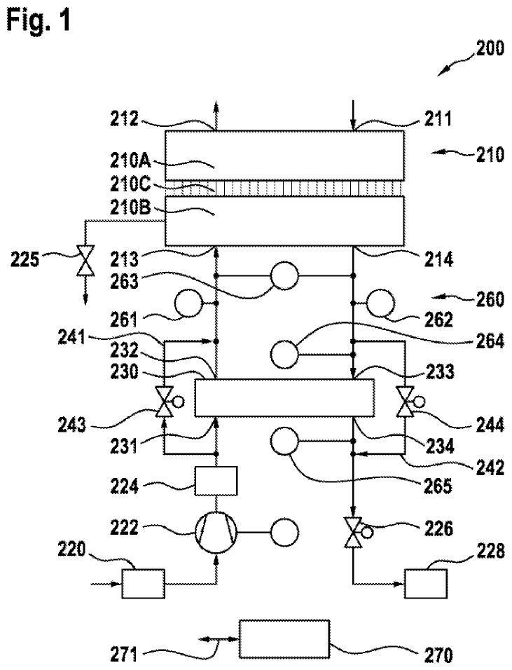

FIG. 1 schematically shows a hydraulic circuit diagram of an exemplary fuel cell system 200, such as can be used in a vehicle, in particular a road vehicle such as a passenger car, truck, bus, or the like.

As shown in FIG. 1 by way of example, the fuel cell system 200 comprises at least one fuel cell 210, a humidifier 230, a sensor system 260, and a control device 270. Optionally, as shown by way of example in FIG. 1, a first bypass line 241 with a first bypass valve 243 arranged therein and/or a second bypass line 242 with a second bypass valve 244 arranged therein can be provided. To transport a mass gas flow, the fuel cell system can also comprise a compressor 222. As further optional components, one or more of the following components shown in FIG. 1 can be provided: a filter 220, an intercooler 224, a drain valve 225, a pressure regulating valve 226, a muffler 228.

FIG. 1 schematically illustrates a fuel cell 210 with an anode 210A, a cathode 210B, and an electrolytic membrane 210C arranged between anode 210A and cathode 210B. The fuel cell further comprises an anode inlet 211 for feeding a gaseous fuel, such as hydrogen, to the anode 210A, an anode outlet 212 for discharging exhaust gas from the anode 210B, a cathode inlet 213 for feeding oxidation gas to the cathode 210B, and a cathode outlet 214 for discharging cathode exhaust gas from the cathode 210B. Only one fuel cell 210 is shown by way of example in FIG. 1. Of course, it can be provided that a plurality of such fuel cells 210 are electrically connected in series to form a stack. In this case, a common fuel inlet 211, a common fuel outlet 212, a common cathode inlet 213, and a common cathode outlet 214 are preferably provided for all fuel cells 210 of the stack.

The humidifier 230 is shown schematically in FIG. 1 only as a block and includes an oxidation gas inlet 231, an oxidation gas outlet 232, an exhaust gas inlet 233, and an exhaust gas outlet 234. As shown in FIG. 1, the oxidation gas outlet 232 is connected in a fluidically conductive manner to the cathode inlet 213, and the exhaust gas inlet 233 is connected to the cathode outlet 214. The oxidation gas inlet 231 is connected in a fluidically conductive manner to a pressure output of the compressor 222, whereby the optional intercooler 224 can be arranged between the compressor 222 and the oxidation gas inlet 231, as shown by way of example in FIG. 1. The exhaust gas outlet 234 is connected to the environment via, e.g., the optional pressure control valve 226 and the optional muffler 228, which preferably forms an outlet into the environment.

The compressor 222 therefore conveys an oxidation gas, e.g. ambient air, to the oxidation gas inlet 231 of the humidifier 230, whereby the compressed ambient air is optionally cooled by the intercooler 224 before reaching the humidifier 230. From the oxidation gas outlet 232 of the humidifier 230, the oxidation gas is fed to the cathode inlet 213 where a reduction of the oxygen contained in the oxidation gas occurs while forming water. The reaction products produced at the cathode are discharged as cathode exhaust gas through the cathode outlet 214 and fed to the exhaust gas inlet 233 of the humidifier 230. The humidifier 230 is configured to extract water from cathode exhaust gas coming from the cathode outlet 214 or to withdraw water from the cathode exhaust gas, e.g., at a membrane (not shown), and from the oxidation gas inlet 231 to the oxidation gas outlet 232 to humidify the extracted or withdrawn water, e.g., by directing the oxidation gas over the membrane of the humidifier 230.

The mass flow of gas through the cathode 210B can be varied by means of the pressure control valve 226 and/or the rotational speed of the compressor 222.

As further shown in FIG. 1, the optional first bypass line 241 connects a point of a flow path of the oxidation gas stream upstream of the oxidation gas inlet 231 of the humidifier 230, e.g. between the intercooler 224 and the oxidation gas inlet 231, to a point of the flow path between the oxidation gas outlet 232 of the humidifier 230 and the cathode inlet while bypassing the humidifier 230. The first bypass valve 243 arranged in the first bypass line 241 can be actuated to vary a flow of oxidation gas through the first bypass line 241 by varying an opening degree of the bypass valve 243. The bypass valve 243 can, e.g., be designed as a solenoid valve having a variable flow cross-section. A portion of the oxidation gas flow directed through the humidifier 230 and a portion of the oxidation gas flow directed through the first bypass line 241 can be freely divided by the first bypass valve 243.

The second bypass line 242 alternatively or additionally provided to the first bypass line 241 connects a point of a flow path of the cathode exhaust gas stream located between the exhaust gas inlet 233 of the humidifier 230 and the cathode outlet 214 to a point of the flow path of the cathode exhaust gas stream downstream of the exhaust gas outlet 234 of the humidifier 230, e.g., between the exhaust gas outlet 234 and the pressure control valve 226 while bypassing the humidifier 230, as shown schematically in FIG. 1. The second bypass valve 244 arranged in the second bypass line 242 can be actuated to vary a flow of cathode exhaust through the second bypass line 242 by varying an opening degree of the bypass valve 244. The bypass valve 244 can, e.g., be designed as a solenoid valve having a variable flow cross-section. A proportion of the cathode exhaust gas stream directed through the humidifier 230 and a proportion of the cathode exhaust gas stream directed through the second bypass line 242 can be freely divided by the second bypass valve 244.

The sensor system 260, as shown by way of example in FIG. 1, comprises a first and a second pressure sensor 261, 262, as well as first and second temperature sensors 264, 265. The first pressure sensor 261 is arranged and configured to detect a pressure between the oxidation gas outlet 232 and the cathode inlet 213, in particular directly at the cathode inlet 213. The second pressure sensor 262 is arranged and configured to detect a pressure between the cathode outlet 214 and the exhaust gas inlet 233, in particular directly at the cathode outlet 214. Alternatively or additionally to the pressure sensors 261, 262, a differential pressure sensor 263 can also be provided that directly detects a pressure difference between the cathode inlet 213 and the cathode outlet 214, as schematically shown in FIG. 1. The first temperature sensor 264 can, e.g., be arranged between the cathode outlet 214 and the exhaust gas inlet 233, as shown by way of example in FIG. 1, and be configured to detect a temperature of the cathode exhaust gas prior to feeding it to the humidifier 230. The second temperature sensor 265 can, e.g., be between the exhaust gas outlet 234 and the optional pressure control valve 226, as shown by way of example in FIG. 1, or generally downstream of the humidifier 230 in the cathode exhaust gas path, and be configured to detect a temperature of the cathode exhaust gas downstream of the humidifier 230. Temperature sensors 264, 265 can be alternatively or additionally provided to the pressure sensors 261-263. Likewise, it is contemplated that the temperature sensors 264, 265 can be replaced by pressure sensors or a differential pressure sensor configured to detect a pressure difference between the exhaust gas inlet 233 and the exhaust gas outlet 234, or that these sensors are provided in addition to the temperature sensors 264, 265. Furthermore, it is also contemplated that the sensor 261 is configured to detect a temperature between the one temperature between the oxidation gas outlet 232 of the humidifier 230 and the cathode inlet 213, whereby in this case a further temperature sensor (not shown) would also be provided upstream of the oxidation gas inlet 231 of the humidifier 230.

The sensor system 260 is thus generally configured to detect a pressure between the oxidation gas outlet 232 and the cathode inlet 232 as well as a pressure between the cathode outlet 232 and the exhaust gas inlet 233 and/or a pressure between the cathode outlet 232 and the exhaust gas inlet 233 and a pressure downstream of the exhaust gas outlet 234, and/or a temperature between the cathode outlet 232 and the exhaust gas inlet 233 and downstream of the exhaust gas outlet 234, and/or a temperature between the cathode inlet 213 and the oxidation gas outlet 232 of the humidifier 230 and upstream of the oxidation gas inlet 231 of the humidifier 230.

The control device 270 is shown symbolically only as a block in FIG. 1 and is realized as an electronic control device. For example, the control device 270 can comprise a processor unit, e.g. in the form of a CPU or the like, and a data storage means, in particular a non-volatile data memory, e.g., in the form of a hard disk, an SD memory, a flash memory, or the like. The data storage means can be read by the processor unit and can store software executable by the processor unit to cause the control device 270 to output control or actuation signals based on input signals.

As shown symbolically in FIG. 1 by double arrow 271, the control device 270 is configured to output and receive electrical and/or electromagnetic signals and is connected in a signal-conducting manner to sensor system 260, e.g., wired via a bus system (not shown), or wirelessly, e.g. via WiFi, blood tooth, or the like. Likewise, control device 270 is connected in a signal-conducting manner to the bypass valve(s) 243, 244 and/or compressor 222 and/or pressure control valve 226 provided, as appropriate.

The control device 70 is configured to output control signals for changing at least one operating parameter of the fuel cell system 200 in order to cause the fuel cell system 200 to perform a method M.

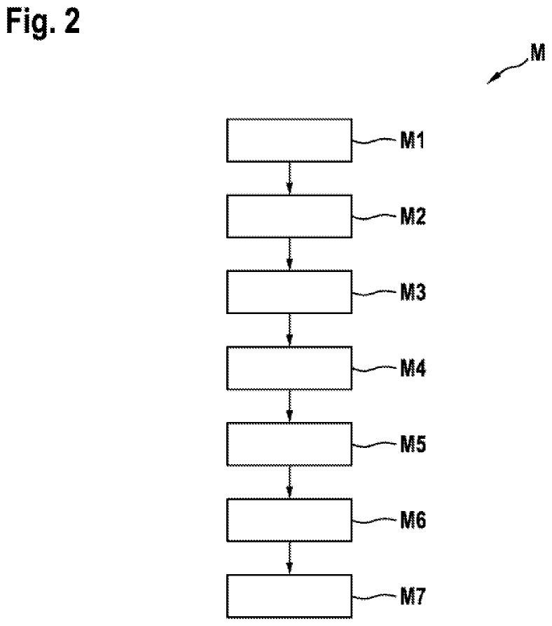

FIG. 2 schematically shows the flow of a method M for operating the fuel cell system 200, which is explained hereinafter using the fuel cell system 200 of FIG. 1 by way of example.

In step M1, the oxidation gas stream is fed to the cathode inlet 213 of the cathode 210B. For this purpose, the control device 270 can, e.g., output a control signal to compressor 222 to cause the oxidation gas flow to be conveyed.

In step M2, the cathode exhaust gas stream is fed from the cathode outlet 214 of the cathode 210B and the exhaust gas inlet 233 of the humidifier 230.

In step M3, the cathode exhaust gas stream in the humidifier 230 is withdrawn, e.g. at a membrane. In step M4, the cathode exhaust gas stream is discharged from the humidifier 230 via the exhaust gas outlet 234 and, if present, discharged into the environment through the pressure control valve 226 and the downstream muffler 228.

In step M5, the oxidation gas stream in the humidifier 230 is humidified by means of the water drawn from the cathode exhaust gas stream, e.g., in the manner described above at the membrane of the humidifier.

In step M6, at least one of the following indicators for the moisture content of the cathode exhaust gas is determined: a pressure drop between the cathode inlet 213 and the cathode outlet 214, a pressure drop between the exhaust gas inlet 233 and the exhaust gas outlet 234 of the humidifier 230, a first temperature difference of the cathode exhaust gas stream between the exhaust gas inlet 233 and the exhaust gas outlet 234 of the humidifier 230, a second temperature difference of the oxidation gas stream between the oxidation gas inlet 231 and the oxidation gas outlet 232 of the humidifier 230.

The pressure drop between the cathode inlet 213 and the cathode outlet 214 as an indicator can be determined in step M6, for example, by detecting the pressure between the humidifier 230 and the cathode inlet 213 by means of the first pressure sensor 261, detecting the pressure between the cathode outlet 214 and the exhaust gas inlet 233 of the humidifier by means of the second pressure sensor 262, and calculating a pressure difference between the detected pressures by means of the control device 270. Alternatively, a pressure difference between the cathode inlet 213 and the cathode outlet 214 can be detected directly with the differential pressure sensor 263 and transmitted as an input signal to the control device 270.

Determining the pressure drop between exhaust gas inlet 233 and exhaust gas outlet 234 of humidifier 230 as an indicator in step M6 can, e.g., comprise detecting a pressure between the cathode outlet 214 and the exhaust gas inlet 233 of the humidifier 230 by means of a pressure sensor (not shown), detecting a pressure downstream of the exhaust gas outlet 234 of the humidifier 230 by way of a further pressure sensor (not shown) of the sensor system 260, and calculating a pressure difference between the detected pressures by means of the control device 270. Alternatively, it is also contemplated to detect the pressure difference between the exhaust gas inlet 233 and the exhaust gas outlet 234 of the humidifier 230 directly by means of a differential pressure sensor.

In step M6, when the first temperature difference of the cathode exhaust gas stream between the exhaust gas inlet 233 and the exhaust gas outlet 234 of the humidifier 230 is determined, this can be done by determining the temperature between the cathode outlet 214 and the exhaust gas inlet 233 of the humidifier 230 by means of the first temperature sensor 264, the temperature downstream of the exhaust gas outlet 234 of the humidifier 230 is detected by means of the second temperature sensor 265, and the difference between the detected temperatures is calculated by means of the control device 270. Similarly, determining the second temperature difference of the oxidation gas stream between the oxidation gas inlet 231 and the oxidation gas outlet 232 of the humidifier 230 comprises detecting a temperature between the oxidation gas outlet 232 of the humidifier 230 and the cathode inlet 213, detecting a temperature upstream of the oxidation gas inlet 231 of the humidifier 230 and calculating the difference between the detected temperatures by means of the control device 270.

In step M7, a moisture feed to the cathode inlet 213 and/or moisture removal from the cathode 210B is varied by adjusting at least one operating parameter of the fuel cell system 200 on the basis of the at least one determined indicator. That is, in step M7, the control device 270 outputs control signals to the components of the fuel cell system 200, e.g., at one or both of the bypass valves 243, 244, to the compressor 222, to the pressure control valve 226, to the drain valve 225, and/or to a coolant conveyor (not shown) by means of which a coolant is conveyed that cools the fuel cell 210. The control signals are determined based on the at least one determined indicator and cause the operating parameters of the fuel cell system to be adjusted, such that an actual value of the determined indicators for the humidity content with cathode exhaust gas stream is maintained within a target range or returned to the target range.

For example, in step M7, the at least one operating parameter of the fuel cell system 200 can be varied such that the determined pressure differences are maintained at a predetermined interval, respectively. The at least one operating parameter of the fuel cell system 200 is optionally varied such that the determined first and/or second temperature difference is maintained in a predetermined range, e.g. in a range between 5° C. and 15° C., in particular between 8° C. and 12° C.

As previously indicated, the moisture content at the cathode 210B, which in particular provides for humidification of the membrane 210C, can be varied or adjusted by varying a moisture feed to the cathode inlet 213 (i.e., a water mass flow into the cathode 210B). In step M7, this can, e.g., be done by feeding the oxidation gas flow to the cathode inlet 213 at least partially via the first bypass line 241. For this purpose, the control device 270 can, e.g., output a control signal to the first bypass valve 243 to adjust an opening degree of the first bypass valve 243 on the basis of the at least one determined indicator. As a result, a proportion of the oxidation gas flow that is humidified in the humidifier 230 can be reduced in order to reduce moisture input into the fuel cell 210 or increased in order to increase moisture input into the fuel cell 210.

Alternatively or additionally, in step M7, the cathode exhaust gas stream of the cathode outlet 214 can be fed past the humidifier 230 at least partially via the second bypass line 242. For this purpose, the control device 270 can, e.g., output a control signal to the second bypass valve 244 to adjust an opening degree of the second bypass valve 244 on the basis of the at least one determined indicator. In the humidifier 230, no water can be removed from the portion of the cathode exhaust gas stream flowing through the bypass line 242. Therefore, the amount of water available for humidification of the oxidation gas stream is reduced. Consequently, a proportion of the cathode exhaust gas stream from which water is removed in the humidifier 230 can be reduced by opening the second bypass valve 244 in order to reduce moisture input into the fuel cell 210, or increased by closing the second bypass valve 244 in order to increase moisture input into the fuel cell 210.

Adjusting the at least one operating parameter in step M7 can thus comprise adjusting the opening degree of one or both bypass valves 243, 244.

Varying the moisture feed to the cathode inlet 213 and/or the moisture removal from the cathode 210B in step M7 can further comprise adjusting one or more of the following operating parameters of the fuel cell system 200:

varying the oxidation gas mass flow. For this purpose, the control device 270 can, e.g., output a control signal to the compressor 222 in order to vary its rotational speed and/or output a control signal to the pressure control valve 226 in order to vary its opening degree.

varying a temperature of the cathode 210B in order to vary an evaporation power on the cathode 210B. For example, the control device 270 can output a control signal to the coolant conveyer (not shown), by means of which coolant that cools the fuel cell 210 is conveyed. As a result, the mass flow of the coolant cooling the fuel cell 210 varies, resulting in a change in the temperature of the cathode 210B.

discharging liquid water from the cathode 210B via the drain valve 225. The control device 270 can, e.g., output a control signal to the drain valve 225 in order to open the drain valve 225 a period of time depending on the determined indicator so that liquid water is discharged from the cathode. The drain valve 225 can, e.g., be designed as a switchable solenoid valve and be connected in a fluidly conducting manner to the cathode.

Although the present invention has been explained hereinabove by way of example with reference to exemplary embodiments, it is not limited thereto and can be modified in many ways. Combinations of the above exemplary embodiments are in particular also conceivable.

1. A method (M) for operating a fuel cell system (200), comprising:
feeding (M1) an oxidation gas stream to a cathode inlet (213) of a cathode (210B) of a fuel cell (210) of the fuel cell system (200);
feeding (M2) a cathode exhaust gas stream from a cathode outlet (214) of the cathode (210B) to an exhaust gas inlet (233) of the humidifier (230);
discharging (M4) the cathode exhaust gas stream from the humidifier (230) via an exhaust gas outlet (234) of the humidifier (230);
humidifying (M5) the oxidation gas stream in the humidifier (230) by means of the water extracted from the cathode exhaust gas stream;
determining (M6) at least one of the following indicators for the moisture content of the cathode exhaust gas: a pressure drop between the cathode inlet (213) and the cathode outlet (214), a pressure drop between the exhaust gas inlet (233) and the exhaust gas outlet (234) of the humidifier (230), a first temperature difference of the cathode exhaust gas stream between the exhaust gas inlet (233) and the exhaust gas outlet (234) of the humidifier (230), a second temperature difference of the oxidation gas stream between the oxidation gas inlet (231) and the oxidation gas outlet (232) of the humidifier (230); and
varying (M7) a moisture feed to the cathode inlet (213) and/or moisture removal from the cathode (210B) by adjusting at least one operating parameter of the fuel cell system (200) based on the at least one determined indicator.

2. The method (M) according to claim 1, wherein determining (M6) the pressure drop between the cathode inlet (213) and the cathode outlet (214) comprises detecting a pressure between the humidifier (230) and the cathode inlet (213), detecting a pressure between the cathode outlet (214) and the exhaust gas inlet (233) of the humidifier, and calculating a pressure difference between the detected pressures, or detecting a pressure difference between the cathode inlet (213) and the cathode outlet (214).

3. The method (M) according to claim 1, wherein determining (M6) the pressure drop between the exhaust gas inlet (233) and the exhaust gas outlet (234) of the humidifier (230) comprises detecting a pressure between the cathode outlet (214) and the exhaust gas inlet (233) of the humidifier (230), detecting a pressure downstream of the exhaust gas outlet (234) of the humidifier (230), and calculating a pressure difference between the detected pressures, or detecting a pressure difference between the exhaust gas inlet (233) and the exhaust gas outlet (234) of the humidifier (230).

4. The method (M) according to claim 1, wherein determining (M6) the first temperature difference of the cathode exhaust gas stream between the exhaust gas inlet (233) and the exhaust gas outlet (234) of the humidifier (230) comprises detecting a temperature between the cathode outlet (214) and the exhaust gas inlet (233) of the humidifier (230), detecting a temperature downstream of the exhaust gas outlet (234) of the humidifier (230), and calculating the difference between the detected temperatures.

5. The method (M) according to claim 1, wherein determining (M6) the second temperature difference of the oxidation gas stream between the oxidation gas inlet (231) and the oxidation gas outlet (232) of the humidifier (230) comprises detecting a temperature between the oxidation gas outlet (232) of the humidifier (230) and the cathode inlet (213), detecting a temperature upstream of the oxidation gas inlet (231) of the humidifier (230), and calculating the difference between the detected temperatures.

6. The method (M) according to claim 1, wherein the at least one operating parameter of the fuel cell system (200) is varied such that the determined first and/or second temperature difference is maintained in a range between 5° C. and 15° C.

7. The method (M) according to claim 1, wherein varying (M7) a moisture feed to the cathode inlet (213) comprises feeding the oxidation gas stream to the cathode inlet (213) at least partially via a first bypass line (241) bypassing the humidifier (230), and/or discharging the cathode exhaust gas stream from the cathode outlet (214) at least partially via a second bypass line (242) bypassing the humidifier (230).

8. The method (M) according to claim 7, wherein, in order to feed the oxidation gas stream to the cathode inlet (213) at least partially via the first bypass line (241), an adjustment of an opening degree of a first bypass valve (243) is performed on the basis of at least one determined indicator, and/or wherein, in order to discharge the cathode exhaust gas stream from the cathode outlet (214) at least partially via the second bypass line (242), an opening degree of a second bypass valve (244) is adjusted on the basis of at least one determined indicator.

9. The method (M) according to claim 1, wherein varying (M7) the moisture feed to the cathode inlet (213) and/or moisture removal from the cathode (210B) comprises adjusting one or more of the following operating parameters of the fuel cell system (200):
varying the oxidation gas mass flow by changing a rotational speed of a compressor (220) that delivers the oxidation gas, or by changing an opening position of a pressure control valve (226) connected to the cathode outlet (214);
varying a temperature of the cathode (210B) to vary an evaporation power at the cathode (210B) by changing a coolant mass flow cooling the fuel cell (210);
discharging liquid water from the cathode (210B) via a drain valve (225).

10. A fuel cell system (200) comprising:
at least one fuel cell (210) having an anode (210A), a cathode (210B), an electrolytic membrane (210C) arranged between the anode (210A) and the cathode (210B), an anode inlet (211) for feeding fuel to the anode (210B), an anode outlet (212) for discharging exhaust gas from the anode (210B), a cathode inlet (213) for feeding oxidization gas to the cathode (210B), and a cathode outlet (214) for discharging cathode exhaust gas from the cathode (210B);
a humidifier (230) having an oxidation gas inlet (231), an oxidation gas outlet (232) connected to the cathode inlet (213), an exhaust gas inlet (233) connected to the cathode outlet (214), and an exhaust gas outlet (234), wherein the humidifier (230) is configured to extract water from the cathode exhaust gas coming from the cathode outlet (214) and to humidify oxidation gas flowing from the oxidation gas inlet (231) to the oxidation gas outlet (232) using the extracted water;
a sensor system (260), which is configured to detect a pressure between the oxidation gas outlet (232) and the cathode inlet (232), as well as a pressure between the cathode outlet (232) and the exhaust gas inlet (233), and/or a pressure between the cathode outlet (232) and the exhaust gas inlet (233) and downstream of the exhaust gas outlet (234), and/or a temperature between the cathode outlet (232) and the exhaust gas inlet (233) and downstream of the exhaust gas outlet (234), and/or a temperature between the cathode inlet (213) and the oxidation gas outlet (232) of the humidifier and upstream of the oxidation gas inlet (231) of the humidifier (230); and
a control device (270) which is connected to the sensor system (260) in a signal-conducting manner and configured to output control signals for changing at least one operating parameter of the fuel cell system (200) in order to cause the fuel cell system (200) in order to perform a method (M) according to claim 1.

11. The fuel cell system (200) according to claim 9, further comprising:
a first bypass line (241) which connects a point of a flow path of the oxidation gas stream located upstream of the oxidation gas inlet (231) of the humidifier (230) to a point of the flow path located between the oxidation gas outlet (232) of the humidifier (230) and the cathode inlet bypassing the humidifier (230), wherein a first bypass valve (243) is preferably arranged in the first bypass line (241), is connected to the control device (270), and can be actuated by the control device (270); and/or
a second bypass line (242) which connects a point of a flow path of the cathode exhaust gas stream located between the exhaust gas inlet (233) of the humidifier (230) and the cathode outlet (214) to a point location of the flow path of the cathode exhaust gas stream located downstream of the exhaust gas outlet (234) of the humidifier (230) bypassing the humidifier (230), wherein a second bypass valve (244) is preferably arranged in the second bypass line (242), is connected to the control device (270), and can be actuated by the control device (270).
